(19) United States
(12) Patent Application Publication
(10) Pub. No.: US 2012/0239432 A1
(43) Pub. Date: Sep. 20, 2012

(54) METHOD AND SYSTEM FOR HEALTHCARE INFORMATION DATA STORAGE

(76) Inventor: Himanshu Desai, Austin, TX (US)

(21) Appl. No.: 13/426,381

(22) Filed: Mar. 21, 2012

Related U.S. Application Data
(63) Continuation of application No. 12/833,620, filed on Jul. 9, 2010, now abandoned.
(60) Provisional application No. 61/224,457, filed on Jul. 9, 2009.

(51) Int. Cl. G06Q 50/24

(52) U.S. Cl. 705/3

(57) ABSTRACT

The invention pertains to managing and storing personal/family/close-ones private medical and health information on a secure personal computer. The application enables better management and tracking of the health and illnesses using health and medical information from the individual which is available and accessible using the technologies ranging from application-to-application electronic exchange to those entered manually and saved in the system. The system stores the information securely and restricts users to authorized information. The information tracked includes and individual's medical profile, incidents, doctor's and hospital's visits, insurance, medications, dosages, refills, periodic/routine tests, notifications, women's health, medical expenses, exercise, nutrition, diet/weight loss, Medicaid/Medicare, family history, genetics, alternate medicines, home remedies, data-to-knowledge-based home diagnosis for preliminary emergency medical care/treatment, etc.

### CROSS REFERENCE TO RELATED APPLICATION

This application claims the priority of previously filed U.S. patent application Ser. No. 61/224,457, filed on Jul. 9, 2009, and entitled “METHOD AND SYSTEM FOR HEALTHCARE INFORMATION DATA STORAGE”.

This application claims the priority of previously filed U.S. patent application Ser. No. 12/833,620, filed on Jul. 9, 2010, and entitled “METHOD AND SYSTEM FOR HEALTHCARE INFORMATION DATA STORAGE”.

### FIELD OF THE INVENTION

The present invention relates generally to the storage of healthcare information, and more specifically to a system for securely storing personal and private healthcare information on a computer.

### BACKGROUND OF THE INVENTION

Medical and health information require extreme privacy and is often more guarded than other types of information. Medical information privacy is a sensitive issue, and is of great concern when it is being recorded and tracked.

The health and medical records for an individual are very rarely in the physical possession of that person. The medical records and supporting documents are more likely to be in the hands of the medical community (doctors, pathology labs, insurance, etc.), rather than with the patient himself. This is odd, especially in today's day and age, when individuals would prefer to be equally responsible and in control of their health. However, without medical records, one cannot get a complete picture and story on their personal condition.

Companies have tried to provide application on the web but have not been able to convince users to store their personal, private medical and health information on the web. Typical users are not confident of their data remaining safe, secure and not misused by unauthorized users.

Currently, there are no acceptable solutions for the tracking and storage of healthcare information in a private and secure manner. It is therefore an object of the present invention to provide a system for using personal computers for the secure storage of healthcare information instead of having to rely on some website to protect one's personal information.

### BRIEF SUMMARY OF THE INVENTION

The present invention relates to a method and system for healthcare information storage when dealing with issues of cost, conflicts, and mismanagements in regard to medical professionals', pharmacies', insurance companies' handling of one's personal and private healthcare information.

In accordance with this invention, there is provided an application wherein personal, private healthcare information obtained from various sources is stored at a local location for secure and easy access to track changes in one's health over age and time.

This application enables users to maintain a medical biography in their own way, which may have visits to a doctor or a hospital involved. This application is non-intrusive and creates very little disruption with regards to the medical industry and its practices, especially with regards to records kept by doctors, hospitals, pharmacies, and insurance companies. This is done in a manner that is better suited for all parties involved in healthcare to continue to evolve towards improved efficiency without requiring an immediate overhaul of existing systems.

This application further pertains to availing referential information that is involved in healthcare. The process of making available such referential information is to meet the same objective of allowing patients to have knowledge of it to upkeep their medical biography.

Across each medical, health record, or functional document type is a set of common instrumentation logic which enables a user with the ability to track: expenses for tax returns, sharing information for social networking, sharing information for community networking, flagging to synchronize with online records, or flagging to synchronize with PDA/Smart Phones. Furthermore, any relevant data will be maintained and updated upon any changes to existing records, changes to entry history, or the creation of new entries.

The kinds of records the application maintains, include the following, but are not limited to:
I) Basic and general information for: a) individual's health and medical profile, b) regional doctor's, physicians, dentists, optometrists and clinic's, c) medications, d) pharmacies, e) insurance companies, f) area hospitals, g) pathology labs, h) nursing homes, i) Medicare/Medicaid. A bunch of these will be auto populated or pre-populated given location details of the individuals.
II) Alternate medications and home remedies
III) Setup for: a) e-mail communications, b) data interface with other applications communications, c) notification when certain data changes, d) access controls for data for different users, individuals or the head of the family.
IV) Activity records for: a) Medical/Health incidents, b) Visits to: Hospitals, Doctors, Nursing homes, c) Incident-based or periodic medical tests results tracking either at home or at the pathology labs, d) Prescriptions and reminders, e) Summarization and visualization of records for trends and knowledge building, f) Instrumentation for various tracking, utility flagging mentioned earlier, g) Selective sharing of certain information as formed-knowledge with friends on social networking, h) Selective sharing of certain information as formed-knowledge with researching people on community networking, i) Support for notifications and reminders of various activities mentioned above, j) Miscellaneous Programs/Plans for tracking of: Weight Loss, Diet/Meal, Nutrition, Exercise leveraging data capturing exercise devices and routines, k) Track changes to existing records as a means to capture who and what changed, e.g. when medications, doctors, insurance companies, pharmacies, etc. change l) synchronize temporary staging of data with online applications, PDA/Smart Phones, and other devices for objective sharing.
V) From the available data, create knowledge, draw inferences and diagnostic recommendations that can be derived for early resolution.

All of the records will be stored locally on an embedded relational database which is queried and added/updated using the SQL language. Flexibility is added and achieved by deploying the application's relational database on a home's central network file/data server. The application, being sensitive to the private nature of healthcare data and importance of preserving medical biographical information, will cover the needs of database storage with support for robust backup and recovery to prevent any loss of data.

### BRIEF DESCRIPTIONS OF THE DRAWINGS

The invention is depicted as simplified model schematics to represent the basic constructs and concepts for the application.

The features, nature, and advantages of the disclosed subject matter will become more apparent from the detailed description set forth below when taken in conjunction with the accompanying drawings, wherein:

FIG. 1 is a block diagram flow chart of the data and functional activity of the healthcare information data storage system in accordance with the present invention.

FIG. 2 is a diagram that depicts the system used in maintaining healthcare setup data.

FIG. 3 is a diagram that depicts the system used in maintaining an individual's healthcare records and the functional entities that enable an individual to make responsible healthcare management decisions.

FIG. 4 is a screenshot of the Welcome & Get Started Screen (photograph).

FIG. 5 is a screenshot of the Member Dashboard Screen, a dashboard for a quick reflection of member's health information and data (photograph).

FIG. 6 is a screenshot of the Member Information & Allergies Screen, member's basic profile and any allergies the member has (photograph).

FIG. 7 is a screenshot of the Member Information & Contacts Screen, member's medical and health profile with list of contacts (photograph).

FIG. 8 is a screenshot of the Member Information & Health Goals Screen, member's medical and health profile with potential to improve and set goals for weight and chronic conditions of BP and Diabetes control (photograph).

FIG. 9 is a screenshot of the Member Information & Immunizations Screen, member's medical and health profile with immunization records over time (photograph).

FIG. 10 is a screenshot of the Member Information & All Insurances Screen, member's medical and health profile and capture of health insurance, dental insurance, vision insurance, Medicare/Medicaid (photograph).

FIG. 11 is a screenshot of the Member Health Problem incident Screen, tracking and history of personal health issues experienced over time from its initial conditions (photograph).

FIG. 12 is a screenshot of the Member Medications Screen, medications history including the current medications and for what conditions (photograph).

FIG. 13 is a screenshot of the Member Schedule Reminders Screen, scheduling of reminders for Doc.'s, Lab visits and for medication reordering and miscellaneous reminders (photograph).

FIG. 14 is a screenshot of the Member Lifestyle Calories data Screen, is to help those consumers and users who like to keep track of their calories consumption and lifestyle activities (photograph).

FIG. 15 is a screenshot of the Member Lifestyle Calories data narrowed down by comparative search filter, is for filtering and weeding through volumes of data through comparative filtering (photograph).

FIG. 16 is a screenshot of the Member Vital (BP & Sugar) Information Screen, for users who have chronic illnesses of Hypertension and Diabetes that they like to control and manage better (photograph).

FIG. 17 is a screenshot of the Member BP Data & Chart with Delta Change from member's normal Screen (photograph).

FIG. 18 is a screenshot of the Member BP (& Sugar) Information with comparative search filter Screen (photograph).

FIG. 19 is a screenshot of the System other data setup menu Screen, available menu containing a list of menu items/commands to startup dialogs to add or update individual data records (photograph).

FIG. 20 is a screenshot of the System Doctors data setup Screen, a simple dialog to capture, add or update doctor's name when launched from the Get Started screen (photograph).

FIG. 21 is a screenshot of the Setup Doctors data Screen, a simple dialog to capture, add or update, doctor's name, ph#s, address, etc. to be used in the system (photograph).

FIG. 22 is a screenshot of the Setup Login data Screen, simple dialog to setup login password and question and answers if loose the password, your questions and your answers (photograph).

FIG. 23 is a screenshot of the Setup Company data Screen, dialog to setup company data that can be of one of the several kinds as applicable to the program, such as; pharmacy, lab, clinic, manufacturer, etc (photograph).

FIG. 24 is a screenshot of the Setup Medicines data Screen, a dialog to setup medicine data that the members take, these would be what you and your family take (photograph).

FIG. 25 is a screenshot of the Setup Foods data (for nutrition/calories) Screen, way to capture a small set of foods that you and the members mostly eat, could add more as you learn and try more (photograph).

FIG. 26 is a screenshot of the Setup Foods data based calories capture Screen, use the calorie values from these founds to capture the calorie values as you identify and select those when you eat them (photograph).

FIG. 27 is a screenshot of the Comprehensive health report data selection Screen, a dialog for user to select and specify data to create a comprehensive health report (photograph).

FIG. 28 is a screenshot of the Create new Member dialog Screen, simple dialog to help user with entering very minimum member data to initiate with creating their profile (photograph).

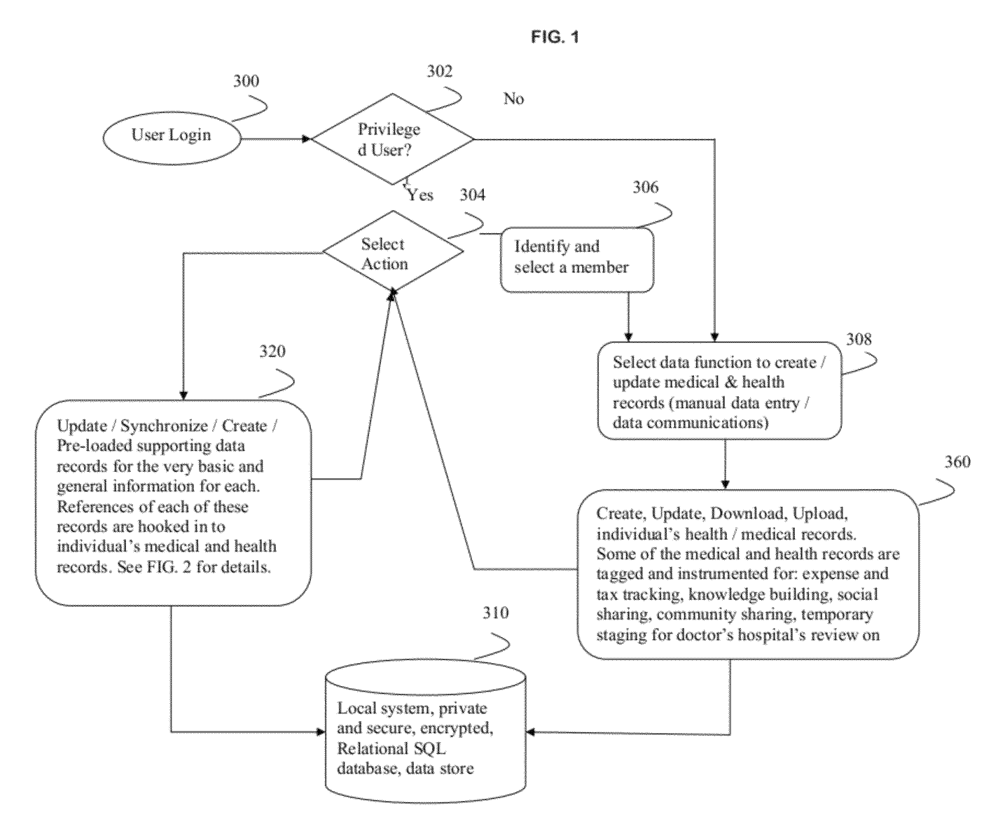

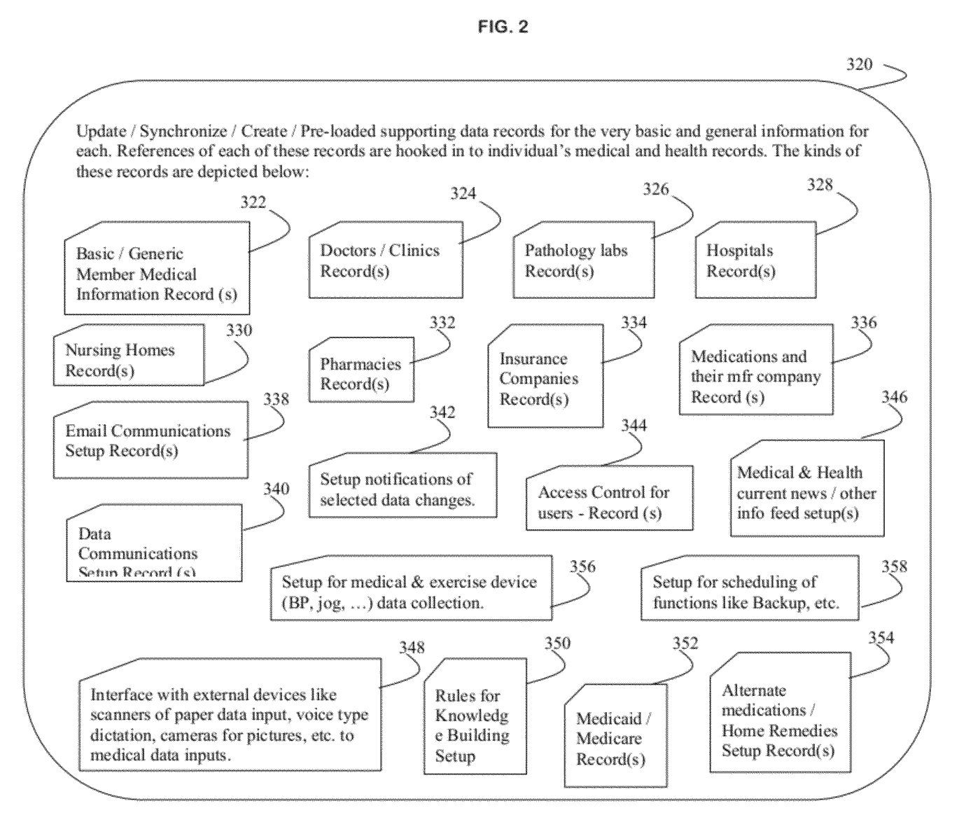

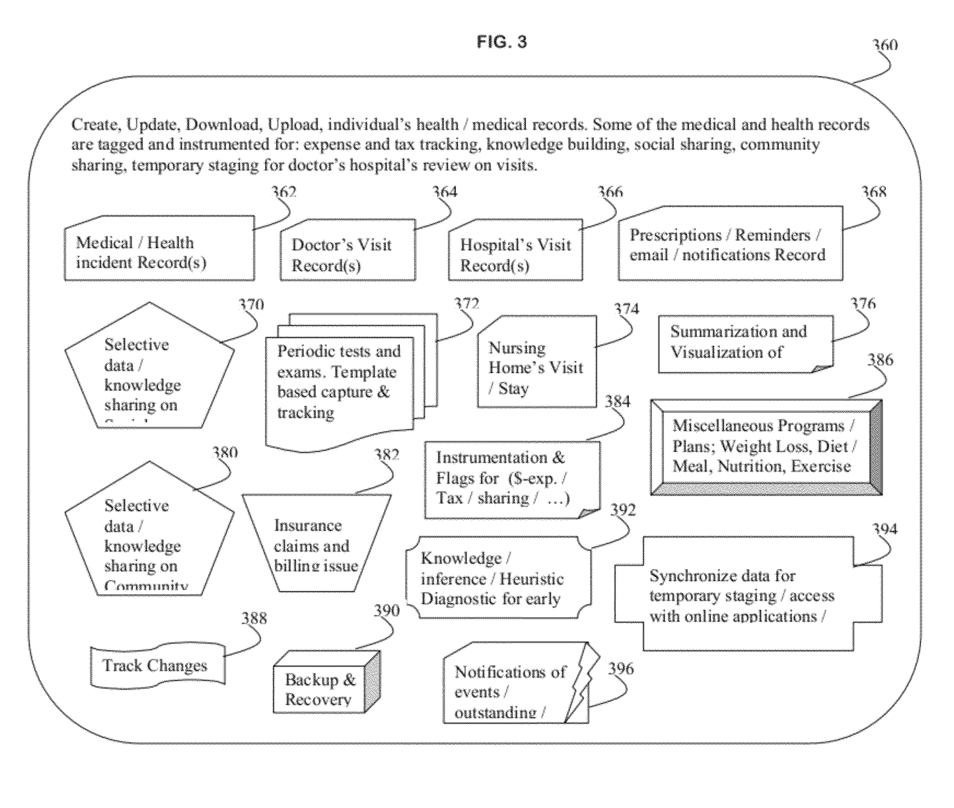

### DETAILED DESCRIPTION OF THE INVENTION

Although described with reference to specific embodiments, one skilled in the art could apply the principles discussed herein to other areas and/or embodiments.

This invention involves owning one's own healthcare information, which is otherwise typically located distant from the individual. This puts individuals at odds when decisions regarding one's health are considered. Patients may want access for reasons as simple as tracking and wanting to improve their or a loved one's health. This invention, through the means of healthcare software application for personal computers, enables and empowers individuals through the virtue of owning their personal healthcare information, to the extent it is of value to them.

Privacy is one of the utmost concerns with healthcare information. As a very sensitive issue, it is appealing to be able to receive personal medical data from healthcare providers in a timely manner for storage in a secure personal system. Through availability of said data, one is better informed and educated of their personal condition. A fundamental premise is that an individual, through this application, now has ease of tracking over time. A further benefit is the ability to leverage that knowledge for proper preventative care, and thus plan for an improved quality of life at a lower cost.

While one might experience some major illness requiring a large volume of information to track, the object of this invention is not to replicate the entirety of all data that doctors, surgeons, and specialists maintain. Rather, the goal is to have a summary of a treatment that may be captured as referential information. Such referential information may include timestamp association, such that at a point in the future, one could get any and all needed information through the referential information. This allows the mass of medical information to continue to be maintained as intended, yet enables an individual to access their own referential material and maintain it in a private and secure system.

Fulfilling this fundamental need to maintain and own one's healthcare information, in a safe and secure way with a feeling of having easy access and full control, is a big facilitator for an individual to keep track of his or her own health. This is also applicable to persons that the user cares about; for example, family, newborn babies, or elderly parents. Having a tool of this kind enables users to be in charge and in full control of their health and health information. This further empowers users and enables a method of using such information in different ways towards the betterment of life and of those they care about.

This application further discloses a method for managing and tracking the personal, private healthcare information of one's individual, family, and friends. One must have full access to such information to track for a better, healthier, and wealthier future. This is to be accomplished by maintaining data primarily on the home personal computer, which is presumably in a secure and private environment. This is presumably an environment where an individual can feel comfortable to maintain private information without any concern of it being accessed and taken by unknown entities. Further, the user in such an environment can easily track personal and private medical and health information for focused and faster results.

An individual with full possession of one's medical and health information can selectively choose segments of such information to share with whomever the individual chooses. This could be on an as needed basis, such as, sharing with a medical provider prior to visiting for consultation and diagnosis. This could also be for sharing experiences and knowledge with friends and family on a social networking participation online.

The source of the data collected and stored will be self-generated and entered by individuals based on “initial stage” conditions and observations. Some exemplary data would be lead-in information created by the medical provider. The initial stages could develop into a later stage warranting a visit to medical providers. Information created and updated by medical providers, physicians, specialists, hospitals, pharmacist, insurance company, etc. could be accessed by individuals on request. The access includes: mail printed copies, e-mail electronic records, secure application-to-application exchange of the records, and the like.

The invention pertains to managing and storing individuals/family/close-ones personal and private medical and health information for management, tracking and rightful ownership of the information. This information is stored on a home/personal computer, which is going to be under the secure environment to hold such private medical and health information. This information stored is sourced through various methods ranging from high-end data communications between the personal computer and the external medical entities software application at a doctor's office, pathology lab, pharmacy etc. to the low-end side as manually entered by the individuals because it is important information to track, deemed important by the conscious owner of that information.

This serves two purposes: 1) when a family member shows signs of ill health, the information can be entered and tracked accurately as the “initial stage” condition, and 2) if the family member's health does not improve and warrants a doctor or hospital visit, the “initial stage” information captured can be accurately shared with the doctor instead of depending on imprecise memories.

Any information maintained from the doctor's (or hospital's) location could be tracked the way they currently operate. This invention does not intend to change any of that. This invention is intended to allow a convenient and easy way for a home user to log and organize information from any medical records initiated at the doctor's or hospital visits. The invention's user can now use this application to track all that in a much more comprehensive and cohesive way.

A typical scenario could be: an individual is faced with an elderly family member having intermittent fevers in the evenings. The details of when it started, are entered into the application and thus the details can be tracked with precision. Subsequently, if the fevers occur again any medications or other treatments given during the first episodes can be recalled with ease. The elderly family member can then be given the same treatment as was originally received to stop the re-occurring fever. An accurate time line of what happened including, when, and what was done, etc, with ease. This did not involve consulting a doctor. A few weeks later if similar fevers start the history of past occurrences is immediately at hand. If the previous treatments failed to work this time and the elderly family member was taken to the doctor, the complete history of the fevers and the prior treatments can accurately and easily be delivered to the doctor. This enables the doctor the ability to diagnose more accurately and quicker without accidentally trying a previously attempted treatment again. After the doctor diagnoses the problem and prescribes a particular treatment, the patient and/or the caretaker can enter the pertinent information from the doctor's visit including medication, how it was administered, and other details about the doctors visit and diagnoses. Furthermore, as the treatment unfolds, the patient can record their progress on the prescribed treatment in case future visits are necessary. If, six months later, the fever returned, the recorded medical information can be retrieved with precision. Therefore, enabling the caretaker or doctor a much clearer picture of the history and evolution of the fevers and the ability to more accurately diagnose and treat the patient.

The subject matter disclosed herein solves two major problems:
1. The patient/caretaker is required to remember all the specific details of the prior incidents/episodes in order to provide a doctor an accurate picture of the initial stages and history of the patient.
2. The patient/caretaker is required to remember of the diagnoses, treatments, prognosis, and progression of the treatment after meeting with the doctor.

In order to assist the patient in addressing these problems: Solution A—the caretaker identifies and selects the pertinent incident records stored on the personal computer and sends/uploads them to the doctor's office. This can be accomplished through secure means prior to the consultation so that the doctor may review the records prior to the appointment. Thereby providing more accurate and complete information to the doctor. Similarly, the doctor's notes, prescriptions, and other information can be downloaded from the doctor's office to the home computer through the same secure means.

Solution B—if the doctor's office is not computerized or their computer is not compatible then the pertinent information can be uploaded to an online medical records storage that the doctor could then access securely. The doctor's notes could then be uploaded to the same online storage for later retrieval by the patient or caretaker.

Solution C—would be to upload the pertinent information onto the patient's or caretaker's PDA or Smart phone to be taken to the doctor's office and shared. Likewise, the doctor's report could be summarized on the same PDA/Smart phone and be synched with the application upon returning home

Solution D—if either of B or C is not an option then the caretaker can print the pertinent information and deliver it to the doctor's appointment and bring back paper copies of the treatment to enter into the system.

This would work similarly for hospital and other types of visits. For hospital visits, the main difference would be in the volume of data, which can be dealt with by obtaining and inputting summary information into the healthcare system. If extensive paper information was obtained, the user could use OCR (Optical Character Recognition) technology to associate the data with the system. Likewise, voice type dictation technology could also be utilized. Another similar interfacing from manual/paper technology to A2A will enable interfacing and exchange of service and data with pharmacies and pathology labs.

Interactions with insurance companies including benefits, claims and billing resolutions are dealt with in similar ways. There is additional functionality in the application to handle tracking of issues and resolutions including tracking of delays, reminders, open issues, consequences and impact.

Interactions with pharmacies and similar organizations would also provide basic information on the drugs and be available to correlate with the prescriptions.

FIG. 1 is a block diagram flow chart of the data and functional activity of the healthcare information data storage system in accordance with the present invention. The invention, the private and personal healthcare information system, is an application for personal computers with their own local and embedded data store 310. As a flexible model of the data store if an individual choose to deploy this application on a home network then access to the data store can be achieved from another device on the network.

The application supports maintaining personal medical and health information for an individual or his or her close ones, family, friends, etc. Each individual whose data is stored in the system could have a unique credentials entered at the login interface. A designated user, potentially a responsible entity like the head of the family, could be granted access to all of the other member's information—a privileged user.

When a user logs in he or she can access his or her data only, unless they are a privileged user. When a privileged user logs in he or she can access others data as well as modify the access control setting of the data by other users.

At the login screen 300, as shown in FIG. 1, a user enters his or her login credentials and is presented with an initial screen containing current health news and alerts and another section displaying outstanding activities and tasks waiting to be performed, e.g. administration of any medications, getting a prescription refill, doctor's appointment, scheduled test, un-entered doctor's visit report, etc. If the user is a privileged user, 302, then he/she gets to select what he/she can do 304: to review/add/update the outstanding activity to perform and chooses to follow the path to 320 to make changes to referential data records or identify and select one of the members or add a new members, to add or update individuals health or medical records, and or perform functions using those records as in 360 for the steps through 306, 308 and to 360.

If the user is not a privileged user then he/she can only review/add/update his/her medical records through step from 302 to 308 to 360, as shown in FIG. 1. Any review/add/update of records in 320 or 360 are stored in the local/home system (personal computer or home network file server—depending on how deployed) in a secure and private relational database with strongly encrypted data that uses SQL (Structured Query Language) to query/add/update/delete of the records.

The user chooses path to 320 to mainly update, synchronize, create, pre-loaded supporting data records for the very basic and general information for the various support data encapsulated in box 320 which supports functional records and activities in 360. Reference of each of these records is hooked or referenced in to individual's medical and health records of the set in 360. The data element and functionalities listed will include those in the application but are not limited to those only.

The Individual's basic medical profile as in 322 is stored in the database which includes: age, sex, weight, height, blood type, body mass fat, pharmacies, insurance, Medicare/Medicaid, allergies, color of eyes, immunizations, storing of genetic information. This also includes tracking of new-born children's vital records, immunizations, development, allergies, etc. which become permanent data of an individual.

The application is preloaded with common/lookup reference data (such as: doctors, medicines, insurance companies, etc.) and modifiable manually or through A2A interface setup.

Doctor's information (includes but is not limited to: name, age, since when, sex, ph #, fax #, contact person, clinic name(s)) companies: type; physician, specialist, surgeon, anesthesiologist, dentist, optometrists, gynecologists, pediatrician, etc. Most information will be pulled from insurance providers, and their associations. Also, the system can store qualitative data, e.g. general ratings on quality of service, how long was the wait, easy to work with, accuracy of diagnosis and prescription for early relief, etc.

Data in 324, 326, 328, 330, 332, 334 and 336 include basic information on doctors, clinics, pathology labs, hospitals, nursing homes, pharmacy, insurance companies, medications and their manufacturing companies, containing general information that include: name, address(es), contact(s), phone(s)/fax numbers, and some distinctly separate & specific information pertaining to each as applicable. E.g. medication information (which includes but is not limited to: manufacturer, cost, generic, side effects, concentration, dosage per age-group) is pre-loaded and updated with data communications interface links with drugs manufacturers. Likewise for 334, insurance information includes: type (health, eye, cost, premiums, employee paid, self, HSA) co-pay for visits/pharmacy, etc.

Technology setup will also include support for: Email, 338, interfaces for data communications, 340, setup with doctors, pharmacy, pathology labs, hospitals, insurance companies, drug manufacturers information, social networking selective sharing, and community networking selective sharing. Setup for current health news feed and government programs, etc. as in 346. Any transmission of records will follow standards for security protocols and protection leveraging technologies including: https, PKI, etc. Setup of these infrastructure information for email, data communications, notifications changes and access controls. Medical and health current news/other information feeds are setup in 338, 340, 342, 344 and 346 that includes general setup information and specific functionality information for each. The application will be setup with data security for accessing data in the system and to create and update as in 344 to maintain levels of access control (login, level, self only, others, what all). The data communication with external applications deploys standards, like HL7 based interfacing involving web services and secure communications protocols on and from a user's personal computer.

Interfacing with external devices for medical and health data input from electronic data to printed text, voice recordings, pictures etc. is captured in 348. Information in 350 contains special rules to help translate pure medical and health records into meaningful knowledge. Information in 352 contains general information for Medicaid and Medicare and information in 354 contains a rich collection of alternate medications and home remedies, which have been passed from generation to generation. Health and medical devices communicating wirelessly to record exercise, calories burned to track weight loss programs as in 356.

Support for backups and backwards compatibility as additional features are added is included as in 358.

The user chooses the path to 360 to mainly create, update, download, upload, individual's health, medical records for the set of functions units encapsulated in 360. Some of the medical and health records are tagged and instrumented for: expense and tax tracking, knowledge building, social sharing, community sharing, temporary staging for doctor's hospital's review on visits and tracking changes.

In 362 an individual's “initial stage” records of any medical and health incidents which will comprise any symptomatic data that includes, but is not limited to: temperature, headache, cold, physical injury, physical changes, de-coloration, photographic images, etc. This initial stage data will be timestamped with any and all specific details. Re-occurring incidents will be linked to previous incidents for continuity and complete history. Incident resolution could lead to visit to a doctor or hospital that is captured with details and specifics of diagnosis and treatment. The data store will be protected and secure and encrypted.

Changes tracking 388: Core level (includes but is not limited to: Changes to of all data of significance, e.g. primary physician, insurance company, etc.), medical and health records of significance. This is user customization to instruments, through tagging.

Prescription records in 374 (includes but is not limited to: name, manufacturer, dosage, expiration, quantity, pharmacy, prescribed by doctor, Brand name, generic, instruction for administration, insurance, how much paid by insurance, remaining paid out of pocket (track for expenses), reminders/notifications, flags: active, administered, completed, reactivate/linked, etc.). Periodic tests and exams 372 (yearly, monthly, daily exam's), record keeping, tracking, charts, comparison with reference, trend setting, age-based, change with age, inference and knowledge statement. Lab tests: blood (for CBC, cholesterol, hormones, organs, all standard/special tests), urine (for- organs, infections, all standard/special tests, etc.), stress, hearing, vision test, optometrists, women's health. A separate function specific template drives each of the test and health types.

As in 364, doctor's visit records (includes data but is not limited to: when visited, who all, check-ups, notes, prescription/medication, qualitative (good, how long wait, etc. as potential for community share)). If this information is available from the doctor's system, it can be retrieved via download from the doctor's system, A2A (Application-to-Application) data communications or through email, and likewise, prescription information could be downloaded or emailed from the pharmacy's system. Likewise as in 366, hospital visits, details (including, but not limited to: when, purpose, doctors involved, hospital information, how long, emergency or admitted). Association of incidents to doctor's visit, prescriptions, follow-ups, improvements, (include tracking of, but not limited to: quality of service, what you liked and what you didn't). Elderly and other medical and health attention including tracking of illness, medications, vitals, periodic tests, etc. is per 374. And stay or visits to nursing homes is contained in 368.

Data summarization and visualization includes, but is not limited to: Life chart, charting of critical data, current medications & administration, changes to tracked history, heuristic predictive assessment and a whole set of visualization of data in pre-defined and user configurable formats appropriate to the specific data as in 376. As in 392, knowledge and inference forming, given all the linked incidents and other medical records draw heuristic and meaningful inferences on health and symptomatic suggestive prediction. The application will track family association that would implicitly link hereditary health data to deduce any health inferences to children and grand children. Medical expenses tracking for IRS and to build a summary of expenses, budget tracking, instrumentation of existing records e.g. medical providers (includes but is not limited to: pharmacy, doctor, hospital, labs, expenses tracking, etc.). Instrumentation for (includes but is not limited to: knowledge building, selective sharing, levels, notification, and expense tracking for tax) as in 384.

Insurance claims and billing issues tracked, to resolution as in 382. As in 394, selectively loading and synchronizing of medical and health records with external applications: a) On-line health records management services for staging of the data to share with the medical providers. b) Smart phone/PDA devices: Selective loading and synchronizing of the data and keeping the information current (potentially to instrument data), leverage platform capabilities to support notifications and reminders. As in 370, participate in online social networking by sharing of selective personal health, medical data with family and friends you like and choose to. As in 380, participate in online community networking of sharing of selective medical information for medical studies, link in with any incentive for doing so: money, promotion, philanthropy, etc. As in 386, miscellaneous programs and plan tracking that includes but not limited to: Health/vitals (BP, sugar, cholesterol, allergies, etc.) tracking, plan tracking for: weight loss, exercise, meal, diet/calories, nutrition, etc.

Data backup and recovery is supported as in 390 and Notifications of event and outstanding reminders on the login screen is referenced in 396.

The invention's development & implementation platform is on a higher-level feature rich language like Java using embedded data store technologies or for added flexibility, is on data store on home network system. The data communication with external applications deploys standards, like HL7, based interfacing involving web services and secure communications protocols on and from a user's personal computer. A subset of data will be enabled to store online and/or on PDA/Smart phones as indicated above and updated as needed through data synch approaches.

The invention, as described covers the scope of functionality in a holistic way. Although described with reference to particular embodiments; however, those skilled in the art, with this disclosure, will be able to apply the teachings in principles in other ways. All such additional embodiments are considered part of this disclosure and any claims below and/or to be filed in the future.

The initial implementation version of the application (a.k.a the program or the system) consists of enabling a user to setup various health at home oriented entity data, such as doctors, pharmacies, clinics, labs, insurance companies, medicines, foods & nutrition, calories consumes and burned, lifestyle, chronic health problems related to vital signs, etc. These constitute as the core and the basic data elements that make the personal and private health information application.

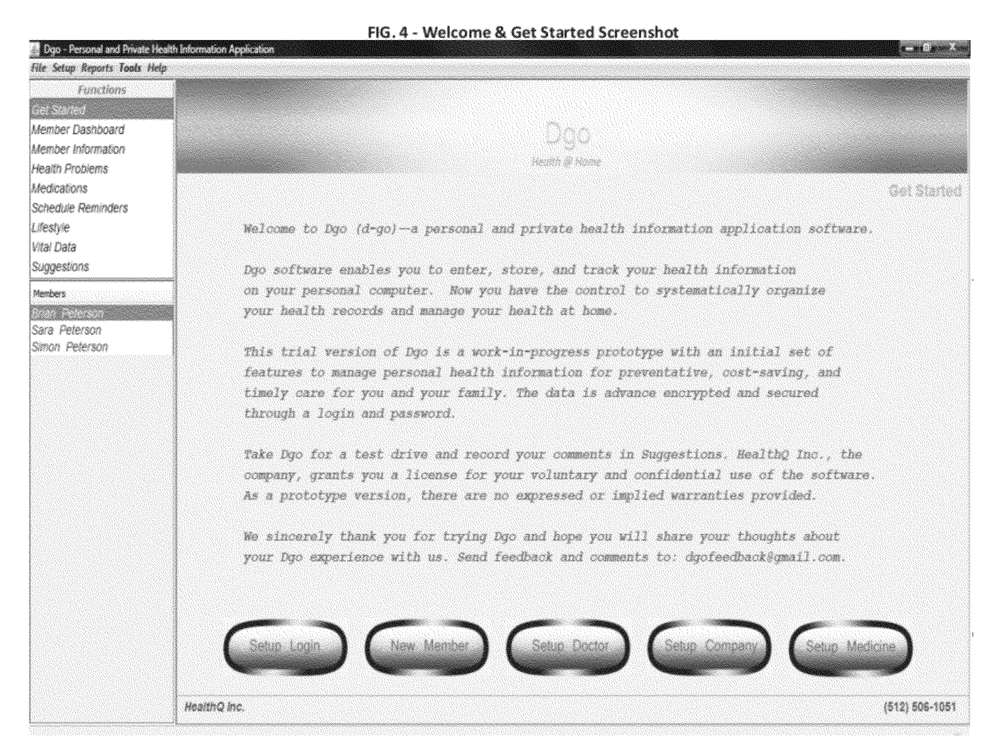

The application supports login control through password setup and checking. All data in the application entered and stored is advance encrypted (256 bit encryptions). The data is stored on the same computer the application is run on. To ease with the setup up of these entity data the application after a successful Login Dialog starts with a welcome and ‘Get Started’ screen. A gentle warranty disclaimer with expectation of confidentiality is stated in the welcome message for the initial trial version. The screen also provides buttons to bring up dialogs to setup Login, Members (family member/caregiver/care receiver), Doctors, Companies (such as pharmacies, clinic, insurance companies, etc.) and Medicines as shown in FIG. 4 (Welcome & Get Started Screenshot)

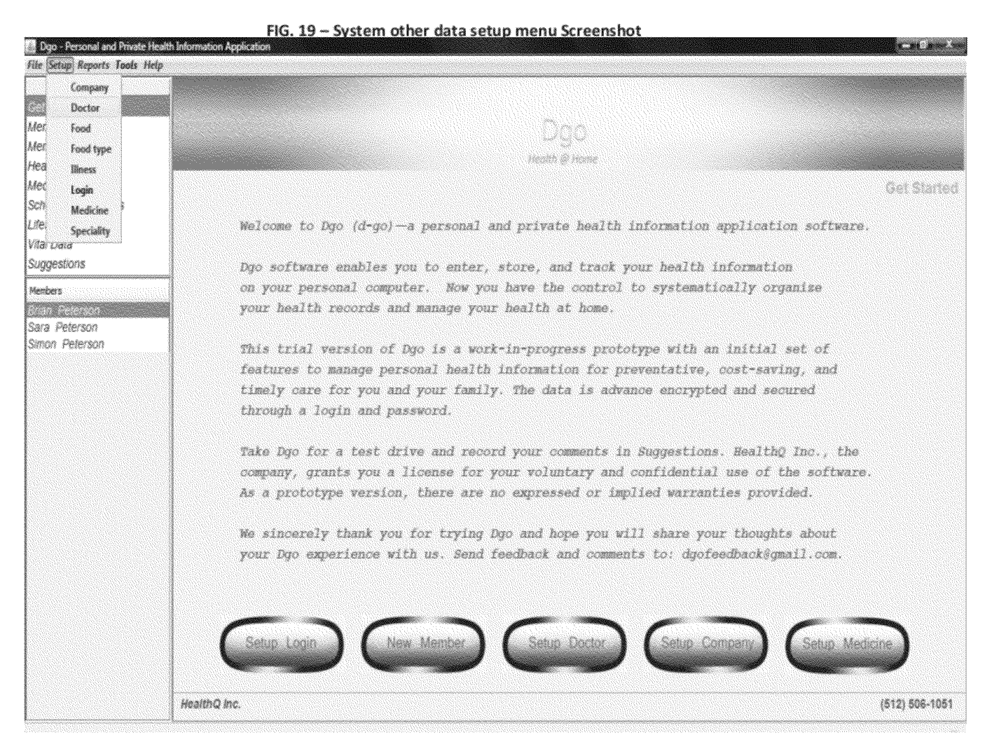

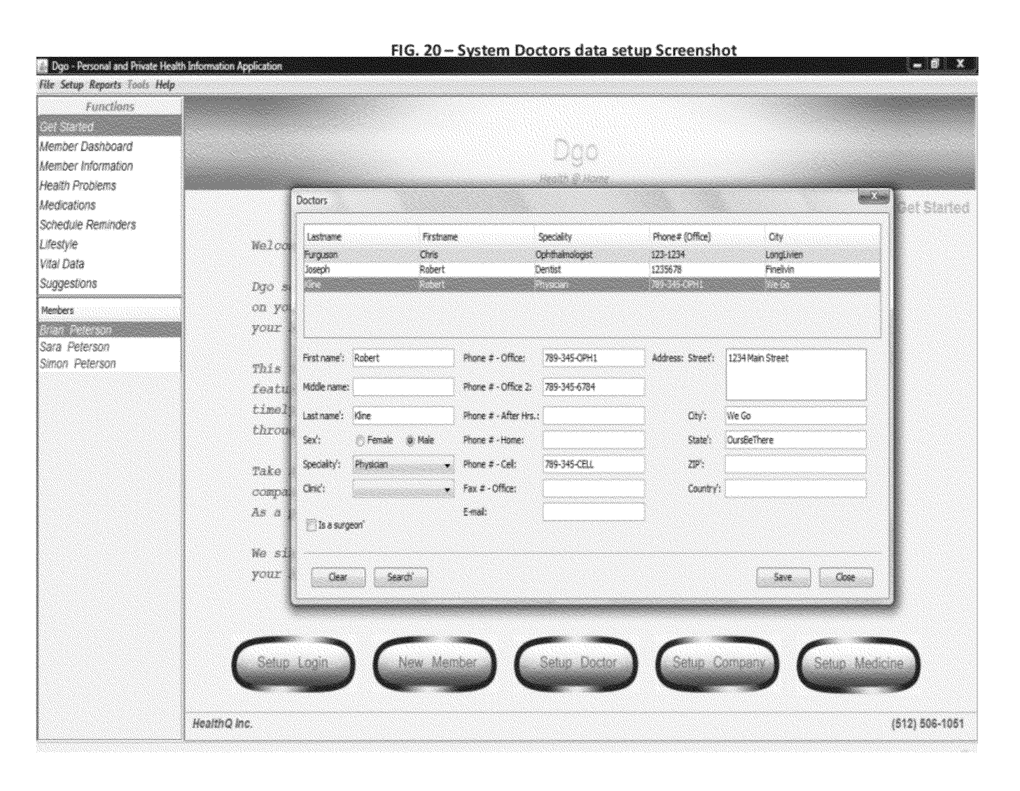

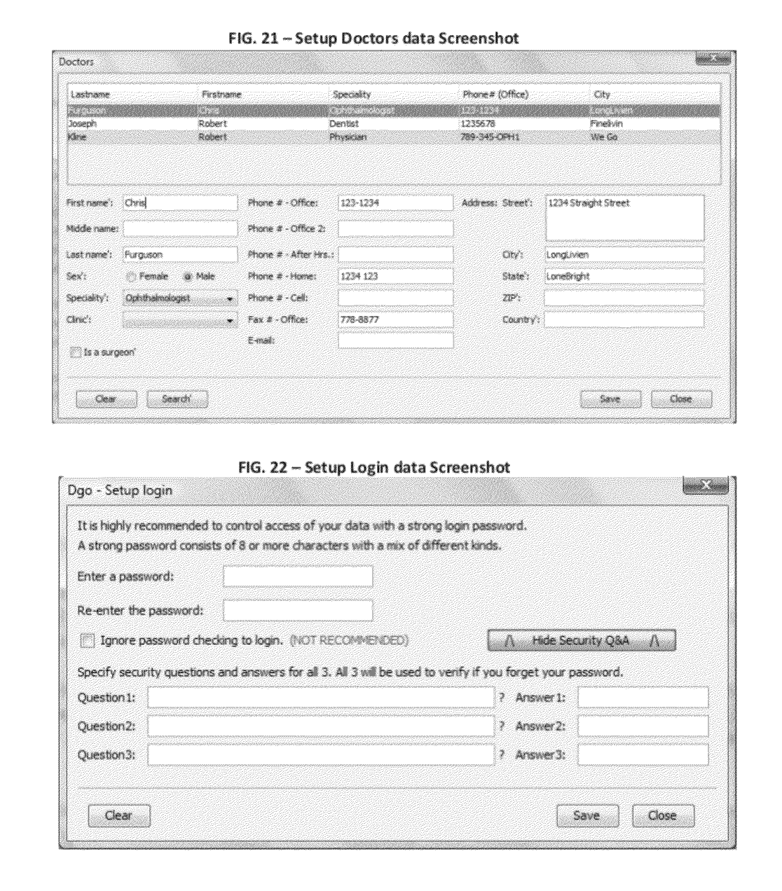

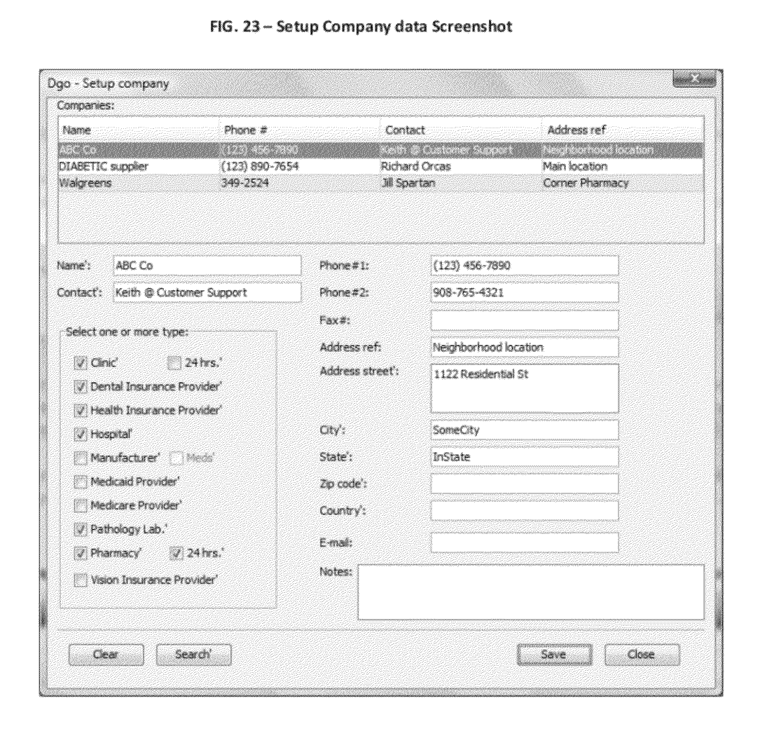

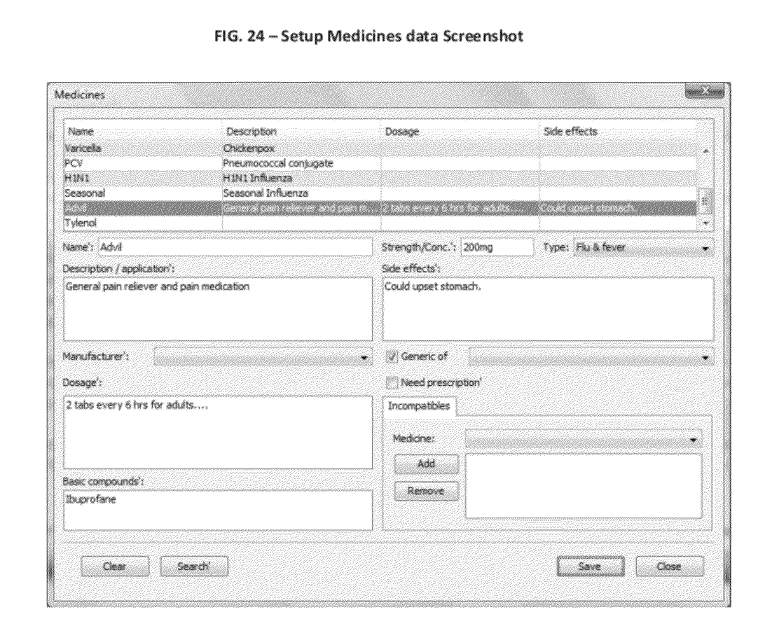

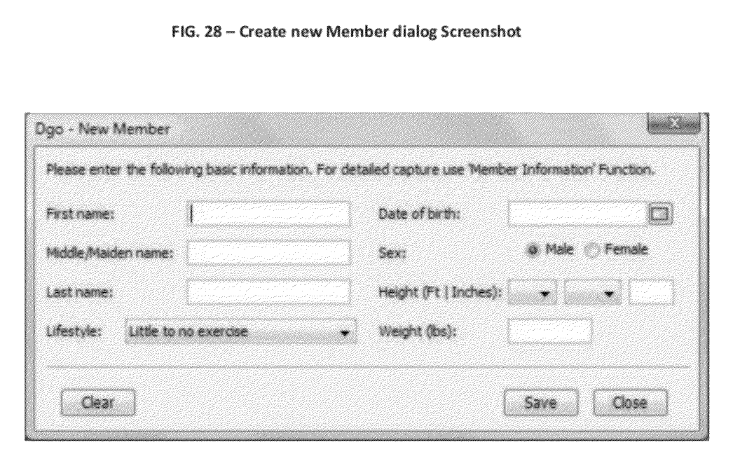

The user can start with setting up the login password and other login data as shown in FIG. 22 (Setup Login data Screenshot). Next the user would need to setup one or more members' data using the new member dialog in FIG. 28 (Create new Member dialog Screenshot) as shown. Use the Setup Doctor button as in FIGS. 20 & 21 (Setup Doctors data Screenshot) to setup one or more doctors to be used as needed with rest of the data information. Next enter and create the data for pharmacies, insurance companies, etc. using the dialog in FIG. 23 (Setup Company data Screenshot). As a last step to get started, use the Setup Medicine as in FIG. 24 (Setup Medicines data Screenshot). There are additional data items and sub-items which can be set from the ‘Setup→’ menu on the top left of the main application window as shown in FIG. 19 (System other data setup menu Screenshot).

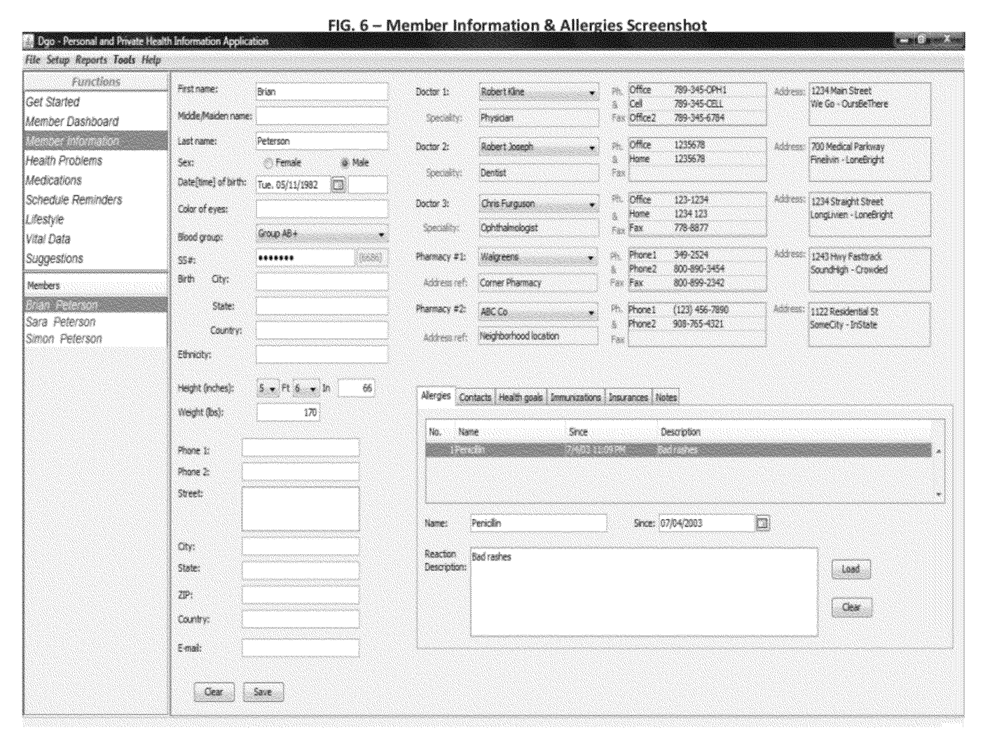

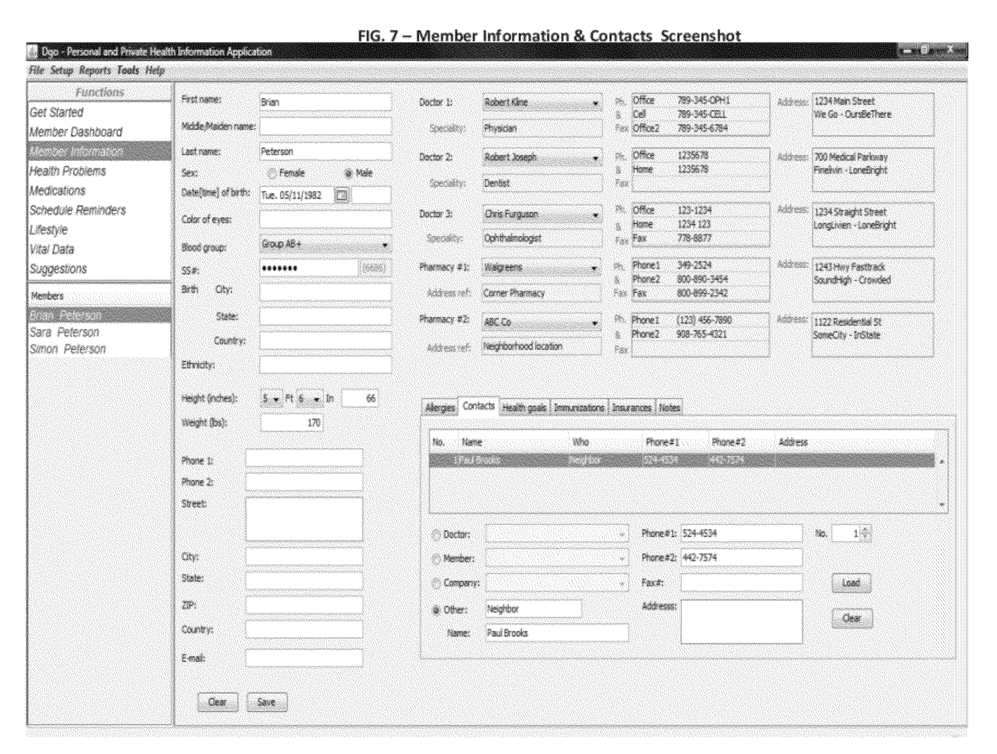

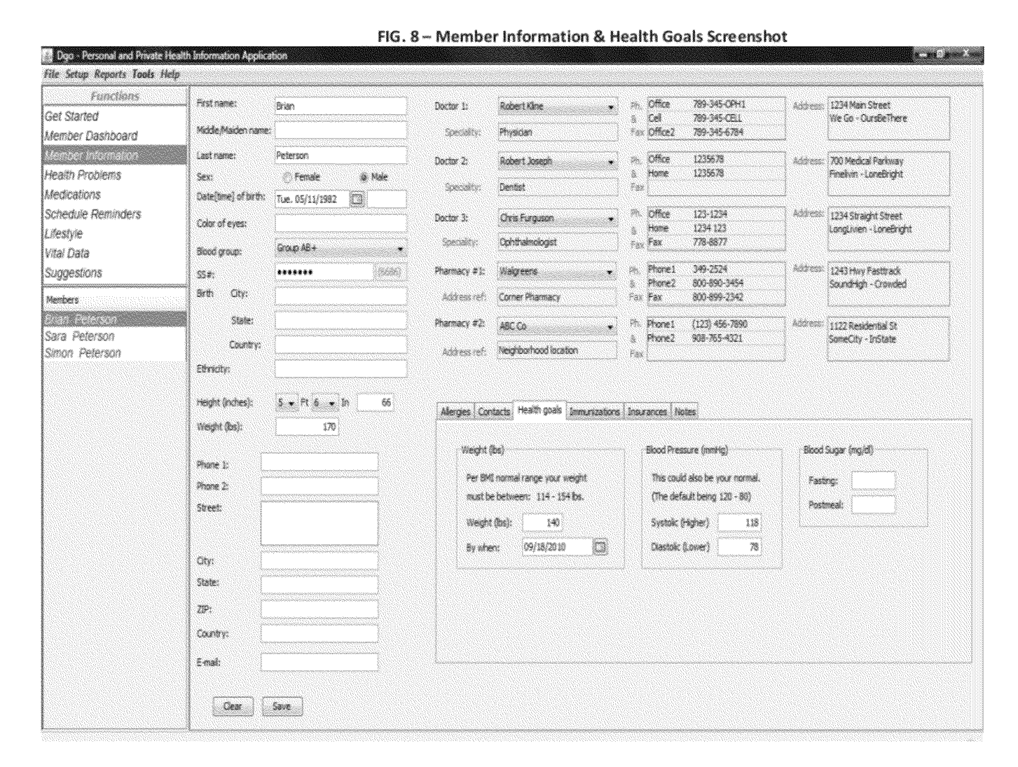

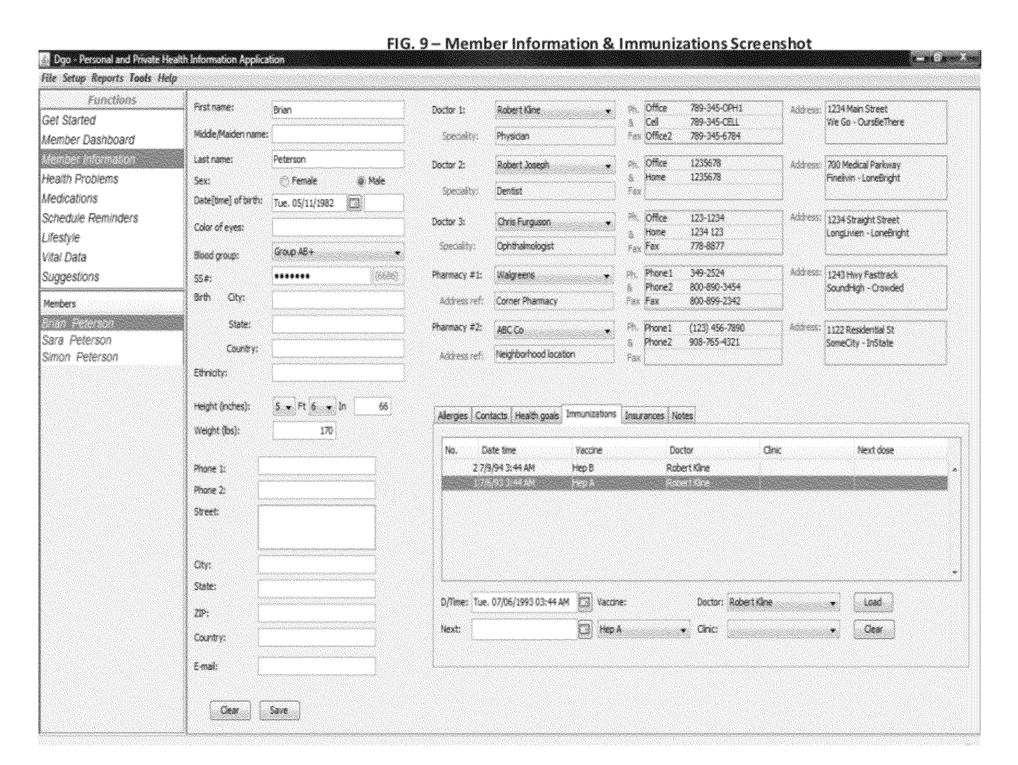

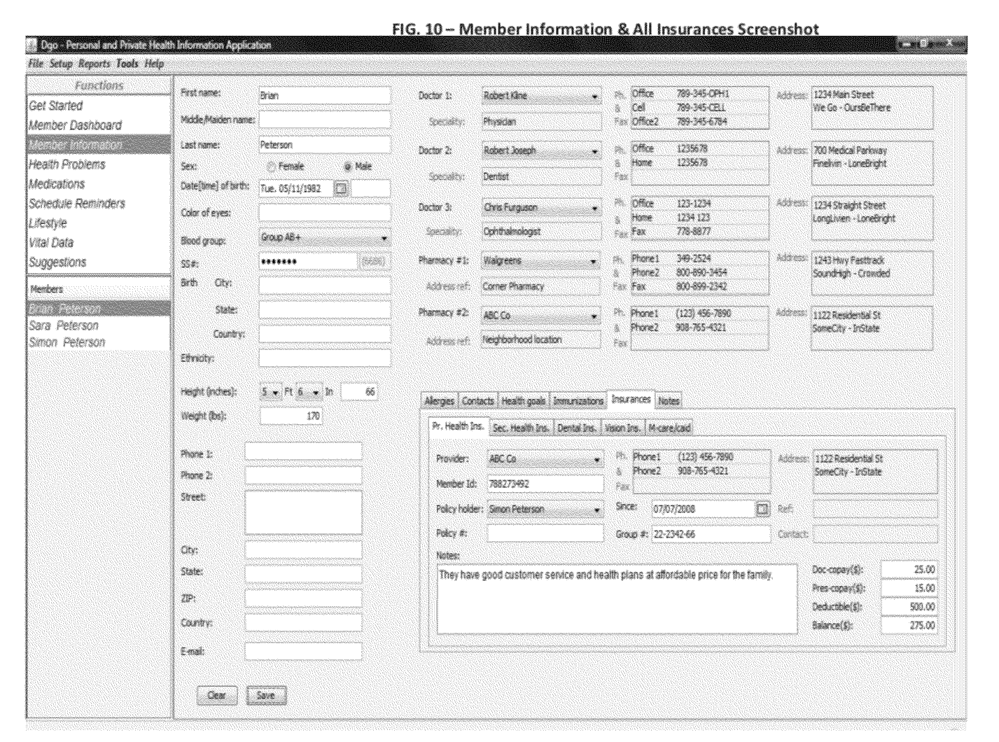

With initial known and startup set of data, the user is ready to setup each member specific data by assimilating each of these data elements accessible through drop down fields as shown the following figures; FIG. 6 (Member Information & Allergies Screenshot). The user can set list of contacts; doctors, family members and other friends through function shown in FIG. 7 (Member Information & Contacts Screenshot). Based on one's lifestyle and any chronic illnesses or vital signs the user can also setup health goals as in FIG. 8 (Member Information & Health Goals Screenshot). Each member's immunization records is stored separately through the functionality in FIG. 9 (Member Information & Immunizations Screenshot). A preloaded set of vaccinations is provided to use to create the records of immunizations. Each member's insurance policy details of the health, dental, vision, Medicare/Medicaid insurances is provided to be stored which comprises of the policy #s, member ID # and phone #s, address, co-pays and deductibles, etc. as shown in FIG. 10 (Member Information & All Insurances Screenshot).

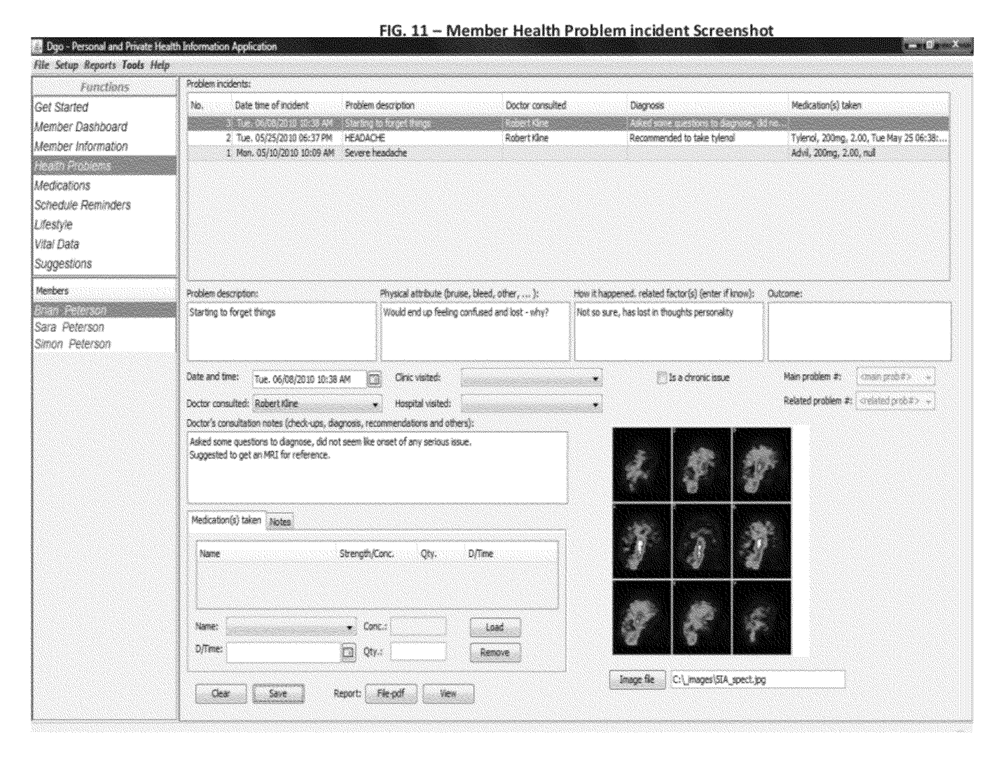

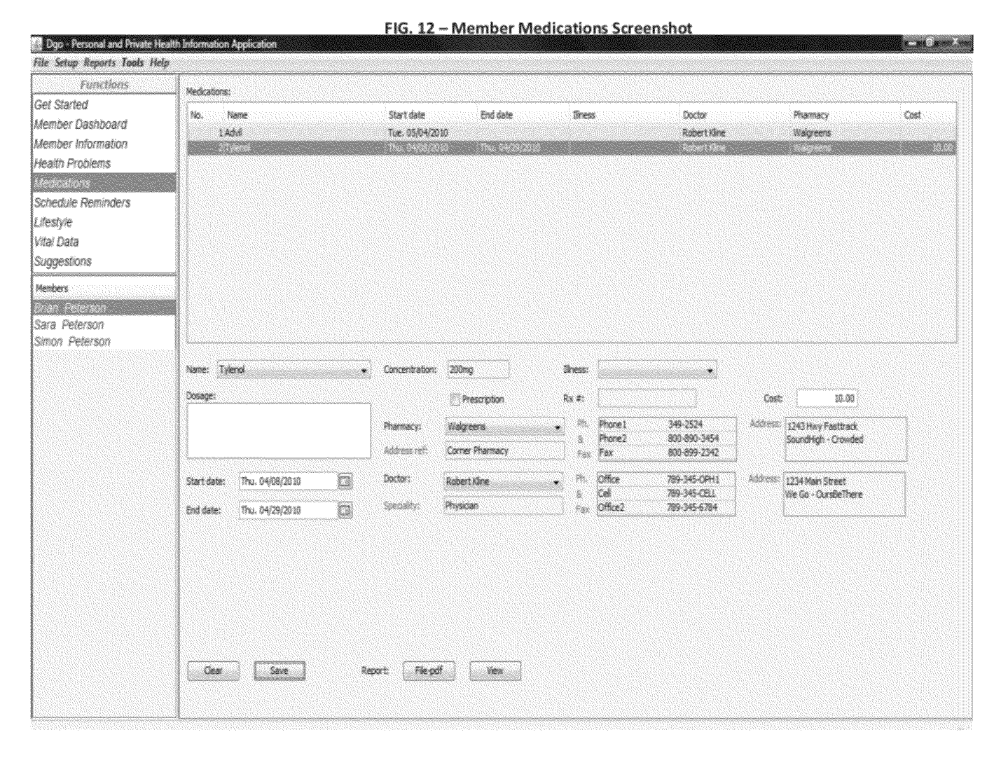

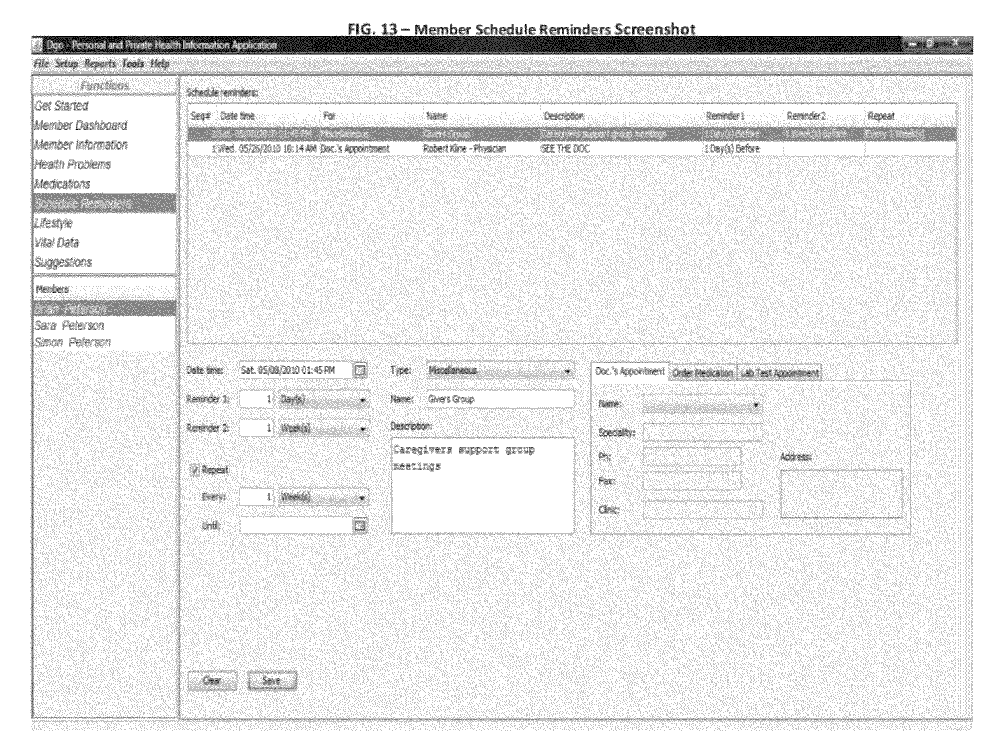

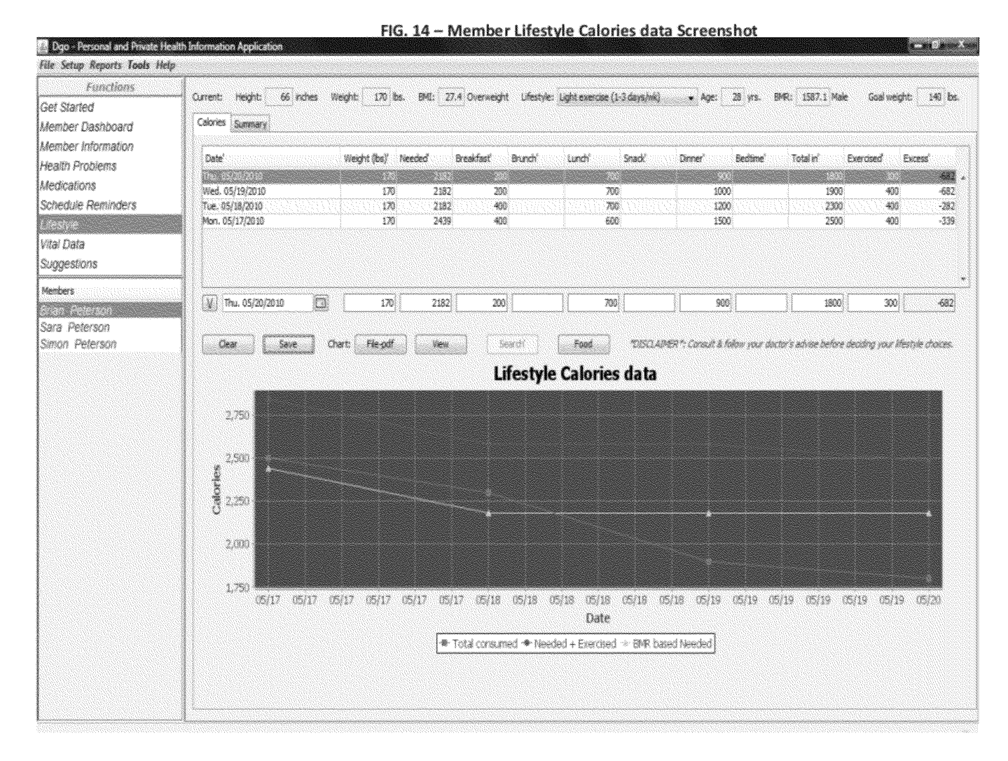

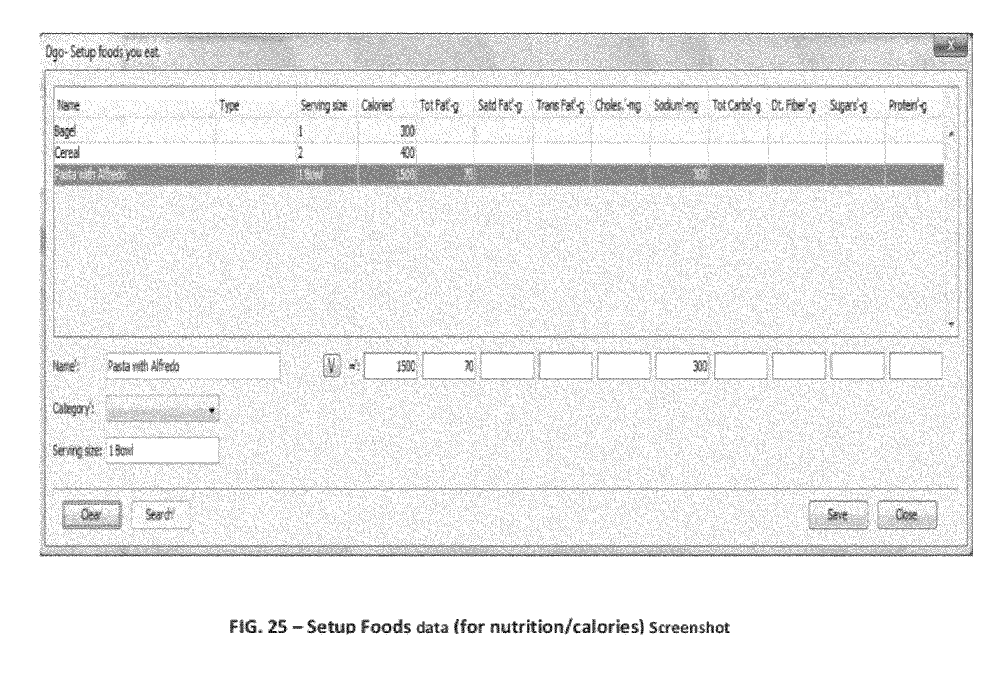

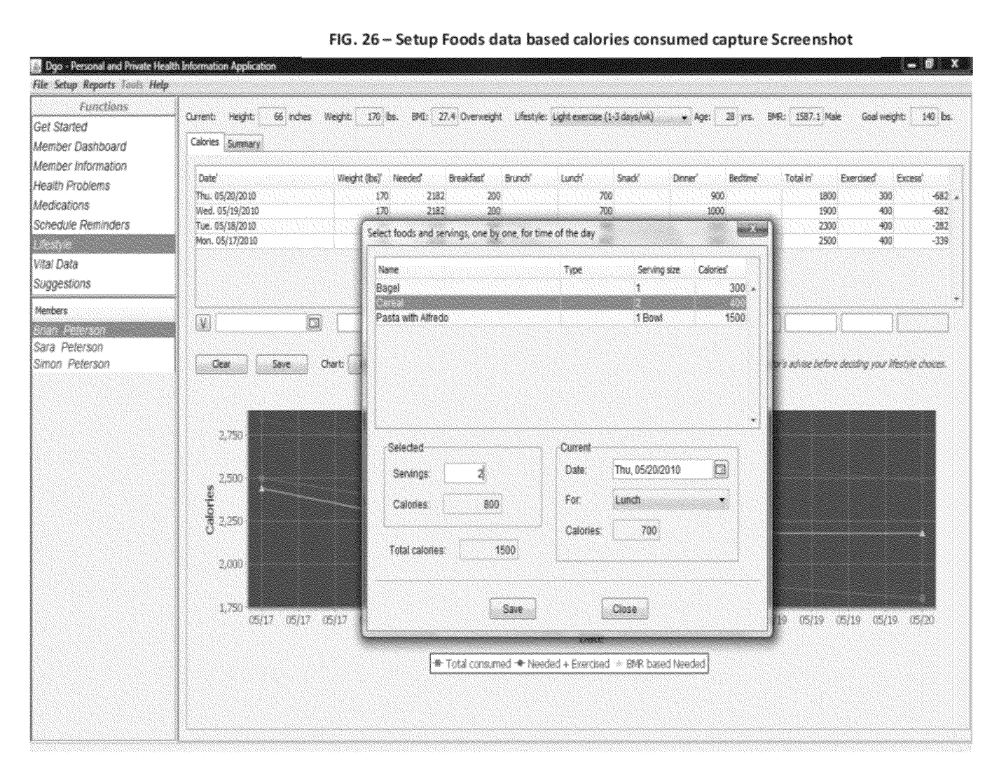

An authorized member/user for himself or herself and/or on behalf of a care receiver can enter the above mentioned data items and values for and also be able to track and monitor health problems through the independent ‘Health Problems’ function as shown in FIG. 11 (Member Health Problem incident Screenshot). Medications; name, illness for, prescribed by, start date and end date, etc. can be tracked using the medication tracking function as show in FIG. 12 (Member Medications Screenshot). Scheduling of reminders for; doctor's appointments, ordering medication refills, lab test appointments and miscellaneous reminders can be setup as shown in FIG. 13 (Member Schedule Reminders Screenshot). Individuals who are tracking their lifestyle for better management of their healthy weight can do so using the Lifestyle functionality that enables an individual to track their BMI, and BMR based calorie consumption over course of each day based derived from the foods consumed and any calories burned by exercising as shown in FIG. 14 (Member Lifestyle Calories data Screenshot). The derivation of calories through association of foods consumed is achieved from the Lifestyle function screen by clicking on the ‘Foods’ button which brings up the dialog as shown in FIG. 26 (Setup Foods data based calories consumed capture Screenshot). The foods data can be setup similar to other data entity setup described and is shown in FIG. 25 (Setup Foods data, for nutrition/calories, Screenshot).

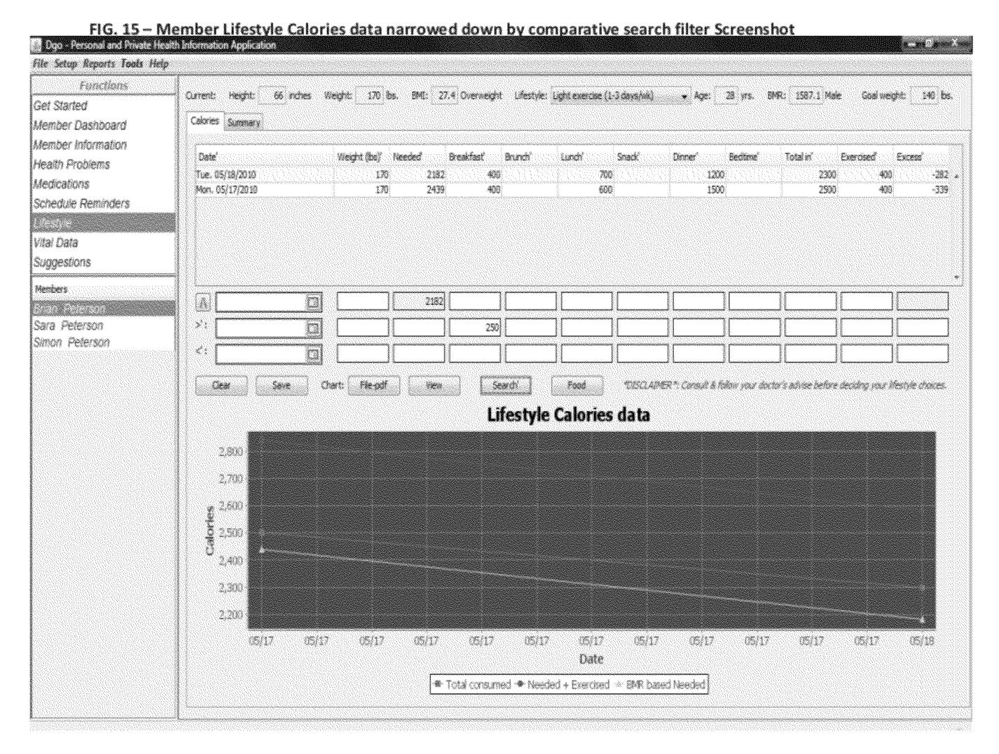

Over time as the data volume increases to better manager and analyze health condition and data searching capabilities are provided across the application. For the Lifestyle data to search on different calorie consumed and/or burned data filtering comparatives (‘=’ equal, ‘>’ greater than and ‘<’ less than) are provided by expanding the fields by clicking on ‘\/’ down arrow button as shown in FIG. 15 (Member Lifestyle Calories data narrowed down by comparative search filter).

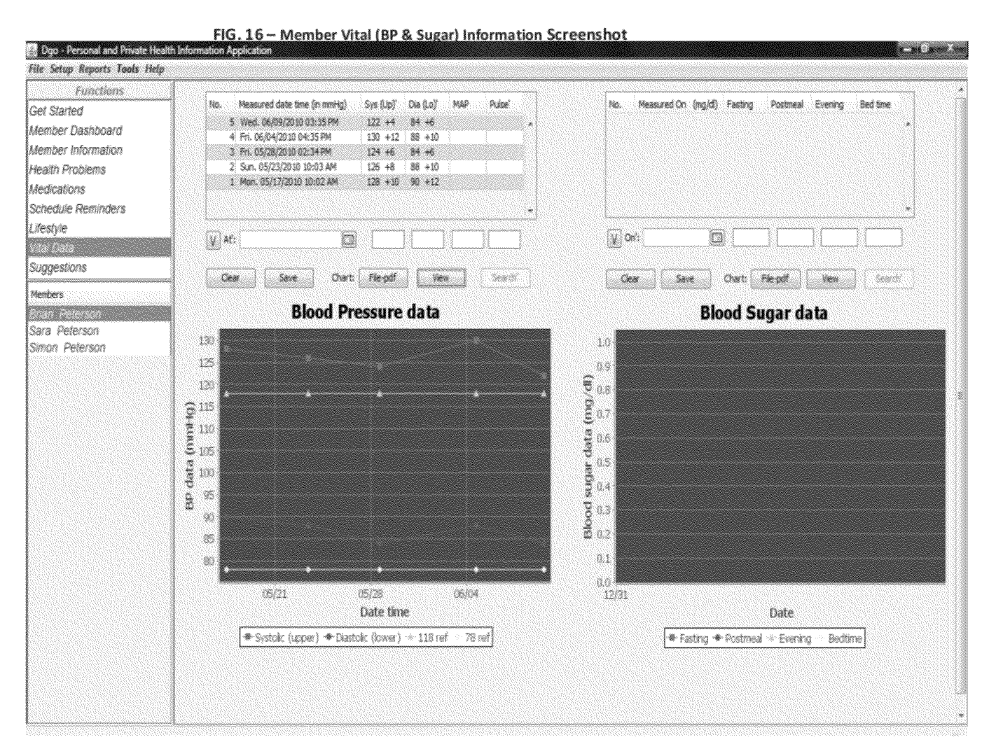

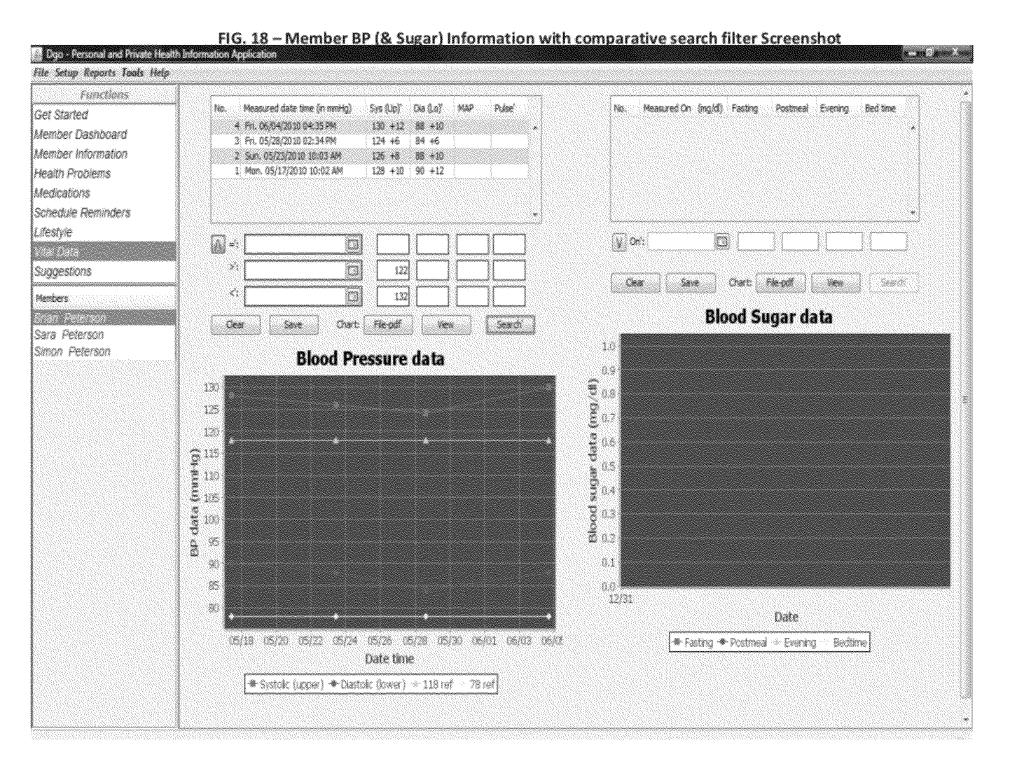

Similar to the Lifestyle management and tracking of calorie balance, tracking of any chronic conditions like Hypertension (BP) or the Diabetes can be done through the Vital Data function as shown in FIG. 16 (Member Vital, BP & Sugar, Information Screenshot). The Blood Pressure data entered is compared against the normal for the member as set in the Health Goals else is compared against the population average. The actual measured data is entered and shown in the tables, also shown are the delta (+/−) difference compared to the reference values mentioned above. Similar to the Lifestyle function filtering through the volume of data for BP and Blood Sugar can be done through the same comparative filtering. By clicking on the ‘\/’ down arrow for each and entering comparative numbers followed by click on the ‘Search’ button filters the data listed the table and also the corresponding chart is updated as shown in FIG. 18 (Member BP & Blood Sugar Information with comparative search filter Screenshot).

The comparative search as described and implemented in this application is a unique and distinguishing feature of this application.

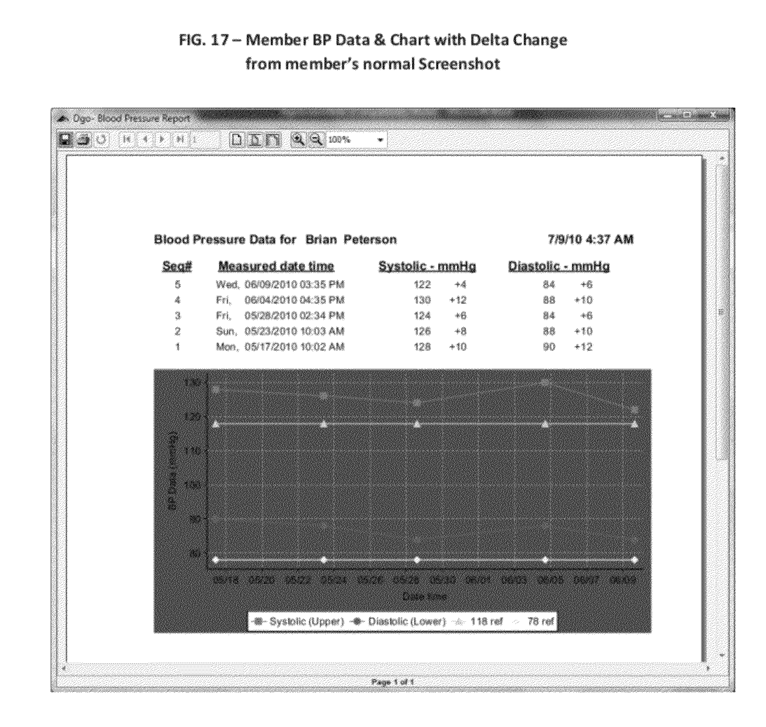

The Lifestyle and the Vitals Data can be charted out in a separate report that can be saved to a pdf file and printed on a printer. An example of such for Blood Pressure data is shown in FIG. 17 (Member BP Data & Chart with Delta Change from member's normal Screenshot).

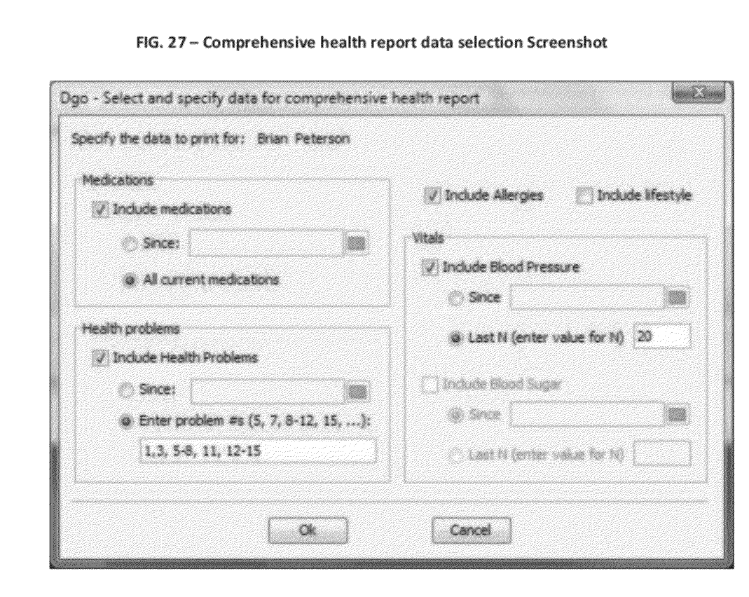

The application support printing of these health data of a member for them to share with their doctor or any health provider they like and choose, the user can print reports on health problems, medications, Lifestyle and Vitals data using the ‘pdf-file’ and ‘View’ buttons on each of the screen. A consolidated comprehensive report for a member can also be generated and printed through selection of one or more such data entities through a special dialog shown in FIG. 27 (Comprehensive health report data selection Screenshot).

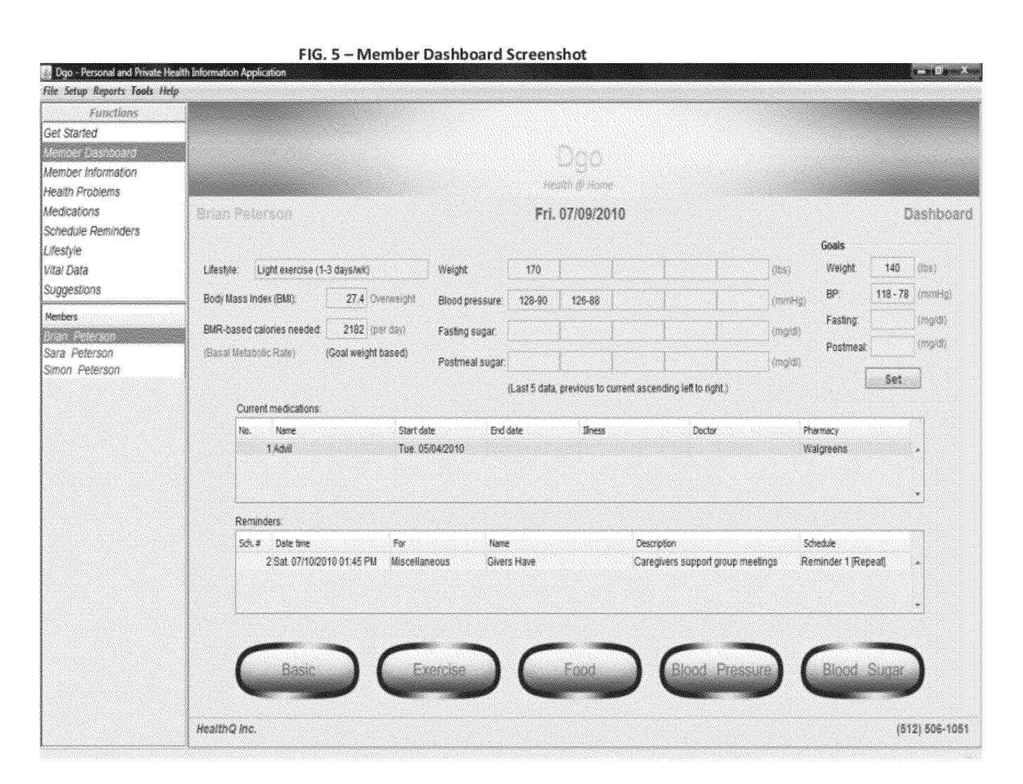

Last but not the least a Dashboard for a member is provided which enables a user to see progress on individuals health over time, set goals, see currently active medications, scheduled reminders based on alert and repeat functionality. Furthermore, the Dashboard also provide buttons for quick data entry on one's weight, calories burned due to exercise, calories consumed through foods, capture individual BP and Blood sugar data as measured as shown in FIG. 5 (Member Dashboard Screenshot).

What is claimed is:

1. A system for healthcare information data storage, comprising:
a set of health records, said set of health records related to a user and comprised of a plurality of healthcare information data obtained from various sources, including medical profile, medical service providers, alternative medications, home remedies, activity records, prescriptions, reminders, or diagnostic recommendations;
a set of common instrumentation logic communicably coupling said plurality of healthcare information data;
an encryption module for enhancing the security and privacy of said set of health records, wherein said set of health records is stored locally on said user's computer, further wherein said computer is selected from the group consisting of a personal computer, a laptop, a mobile phone, a personal digital assistant, a tablet, a server, and an embedded relational database;
a portal enabling access to said computer; and
a communications medium, said communications medium permitting said user to securely transmit at least one subset of said health records to a healthcare service provide and enabling communications between said healthcare service provider and said user.
